(19) United States
(12) Patent Application Publication
(10) Pub. No.: US 2014/0327245 A1
(43) Pub. Date: Nov. 6, 2014

(54) GENERATOR AND FLYWHEEL

(71) Applicant: CARRIER CORPORATION, Farmington, CT (US)

(72) Inventor: John T. Steele, Marcellus, NY (US)

(21) Appl. No.: 14/364,847

(22) PCT Filed: Dec. 20, 2012
(86) PCT No.: PCT/US2012/070843

§ 371 Date: Jun. 12, 2014

Related U.S. Application Data
(60) Provisional application No. 61/579,853, filed on Dec. 23, 2011.

(51) Int. Cl. H02K 7/18; H02K 7/02

(52) U.S. Cl. CPC H02K 7/1807; H02K 7/02; H02K 7/1815
USPC 290/1 A

(57) ABSTRACT

An engine and generator arrangement includes an engine having a rotatable output shaft and a flywheel located in a bell housing and operably connected to the output shaft. The flywheel includes a permanent magnet located at a radially distal end of the flywheel that magnetically interacts with a radially adjacent stator of the bell housing to generate electrical power. An electrical generator includes a bell housing and a flywheel disposed in the bell housing. The flywheel is driven by an engine and includes a permanent magnet located at a radially distal end of the flywheel that magnetically interacts with a radially adjacent stator within the bell housing to generate electrical power.

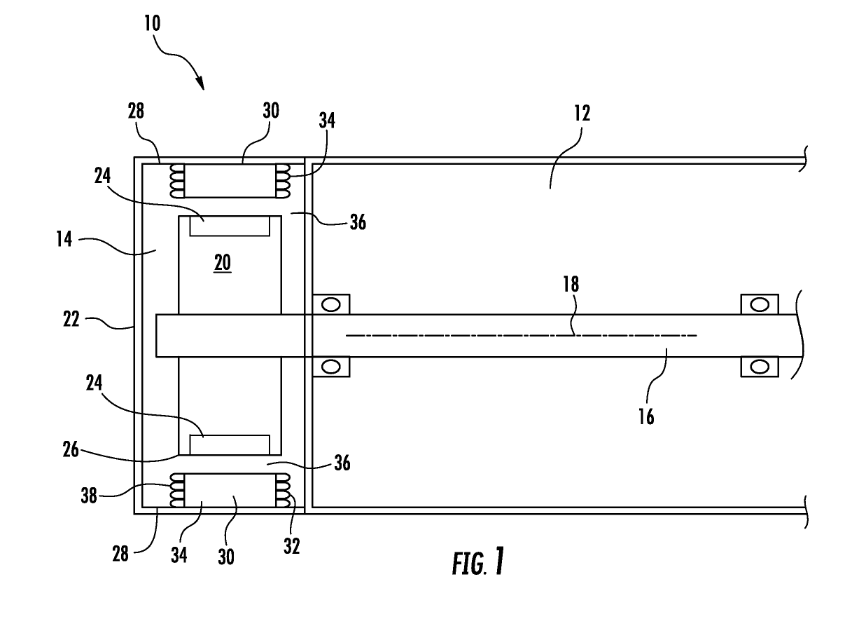

### BACKGROUND OF THE INVENTION

The subject matter disclosed herein relates to generators. More specifically, the subject disclosure relates to the interface between a generator and an engine flywheel.

In a typical engine and generator arrangement, the engine has an output shaft that is connected to a flywheel typically located in a bell housing. The generator, located in its own housing, is connected to the bell housing, with the generator rotor connected to the flywheel. Rotation of the engine output shaft drives rotation of the flywheel, which in turn, drives rotation of the generator rotor to produce electrical power by interaction of the rotor and the stator of the generator motor.

The engine, coupled with the flywheel and generator take up a large amount of valuable space in, for example, a mobile refrigeration unit or engine compartment. Further, the moment and overhung mass of the typical engine and generator arrangement results in wear issues with the engine main bearings. The art would well receive improvements in the engine and generator arrangement that would result in space savings and/or reduction in bearing issues.

### BRIEF DESCRIPTION OF THE INVENTION

According to one aspect of the invention, an engine and generator arrangement includes an engine having a rotatable output shaft and a flywheel located in a bell housing and operably connected to the output shaft. The flywheel includes a permanent magnet located at a radially distal end of the flywheel that magnetically interacts with a radially adjacent stator of the bell housing to generate electrical power.

According to another aspect of the invention, an electrical generator includes a bell housing and a flywheel disposed in the bell housing. The flywheel is driven by an engine and includes a permanent magnet located at a radially distal end of the flywheel that magnetically interacts with a radially adjacent stator within the bell housing to generate electrical power.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawing in which:

The FIGURE is a cross-sectional view of an embodiment of an engine and generator arrangement.

The detailed description explains embodiments of the invention, together with advantages and features, by way of example with reference to the drawing.

### DETAILED DESCRIPTION OF THE INVENTION

The FIGURE illustrates an embodiment of an engine and generator arrangement. In some embodiments, the arrangement is a genset 10, including an engine 12 and an electrical generator 14. The engine 12 may be an internal combustion engine powered by, for example, gasoline or diesel. It is to be appreciated that other types of engines, such as steam turbines or gas turbines, and other types of fuel are contemplated within the scope of the present disclosure. The engine 12 is coupled to the generator 14 such that operation of the engine 12 causes the generator 14 to generate electrical power.

The engine 12 includes an output shaft 16 which rotates about an engine axis 18 and is connected to a flywheel 20 located in a bell housing 22. In some embodiments, the bell housing is affixed directly to the engine 12. In this genset 10, the flywheel 20 is also a rotor of the generator 14. To that end, the flywheel 20 includes a plurality of permanent magnets 24 arranged at a perimeter 26 of the flywheel 20 facing an internal wall 28 of the bell housing 22.

The bell housing 22 contains a stator 30 of the generator 14 radially outboard of the flywheel 20. The stator 30 may include one or more stator windings 32 each winding 32 including one or more conductors 38 installed in a stator core 34 extending inwardly from the internal wall 28. In operation, as the output shaft 16 is rotated by the engine 12, the flywheel 20 is rotated. Rotation of the flywheel 20 causes magnetic interaction between the permanent magnets 24 of the flywheel 20 and the stator windings 32 across an air gap 36 between the flywheel 20 and the stator 30 to generate electrical power.

The genset 10 disclosed herein utilizes the flywheel 20 as the generator rotor and the bell housing 22 as the stator, rather than having a generator assembly contained in a separate generator housing in addition to the flywheel and bell housing as in the typical genset. The genset 10 has a reduced axial length compared to a typical genset, thus allowing space to be utilized for other components. Further, the generator 14 has a shorter moment arm thus resulting in reduced wear to an engine main bearing (not shown).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An engine and generator arrangement comprising:
an engine having a rotatable output shaft; and
a flywheel driven by the output shaft and comprising a permanent magnet located at a radially distal end of the flywheel that magnetically interacts with a radially adjacent stator disposed in a bell housing to generate electrical power.

2. The engine and generator arrangement of claim 1, wherein the permanent magnet is disposed at a perimeter of the flywheel.

3. The engine and generator arrangement of claim 1, further comprising one or more stator windings disposed in the bell housing.

4. The engine and generator arrangement of claim 3, wherein the one or more stator windings are disposed at a stator core disposed in the bell housing.

5. The engine and generator arrangement of claim 1, wherein the bell housing is affixed to the engine.

6. An electrical generator that is driven by an engine, the electrical generator comprising:
a bell housing; and
a flywheel driven by the engine and comprising a permanent magnet located at a radially distal end of the flywheel that magnetically interacts with a radially adjacent stator disposed in the bell housing to generate electrical power.

7. The generator arrangement of claim 6, wherein the permanent magnet is disposed at a perimeter of the flywheel.

8. The generator arrangement of claim 6, further comprising one or more stator windings disposed in the bell housing.

9. The generator arrangement of claim 8, wherein the one or more stator windings are disposed at a stator core disposed in the bell housing.

10. The generator of claim 6, wherein the bell housing is affixed to the engine.
